(19) United States
(12) Patent Application Publication
(10) Pub. No.: US 2022/0394410 A1
(43) Pub. Date: Dec. 8, 2022

(54) VOICE OUTPUT CONTROL DEVICE, CONFERENCE SYSTEM DEVICE, AND COMPUTER-READABLE STORAGE MEDIUM

(71) Applicant: JVCKENWOOD Corporation, Yokohama-shi (JP)

(72) Inventors: Kazuomi Tachigi, Yokohama-shi (JP); Hiroyuki Gunji, Yokohama-shi (JP)

(21) Appl. No.: 17/889,428

(22) Filed: Aug. 17, 2022

Related U.S. Application Data
(63) Continuation of application No. PCT/JP2020/047773, filed on Dec. 21, 2020.

(30) Foreign Application Priority Data
Mar. 19, 2020 (JP) 2020-048730

(51) Int. Cl. H04S 7/00; H04L 12/18

(52) U.S. Cl. CPC H04S 7/30; H04L 12/1822; H04S 2400/11

(57) ABSTRACT

A voice output control device includes a base control unit configured to set, based on information on relative positions between an own base of the base control unit and other bases, a direction of a position where voice to be output to each of the other bases is localized, and set, based on information on relative distances between the own base and the other bases, a height of the position where the voice is localized; and a sound source processor configured to localize voice from the other base to generate a voice signal to be output, based on the position set by the base control unit.

### CROSS-REFERENCE TO RELATED APPLICATIONS

This application is a Continuation of PCT International Application No. PCT/JP2020/047773 filed on Dec. 21, 2021 which claims the benefit of priority from Japanese Patent Application No. 2020-048730 filed on Mar. 19, 2020, the entire contents of which are incorporated herein by reference.

### BACKGROUND

The present disclosure relates to a voice output control device, a conference system device, and a computer-readable storage medium.

As a system for a conference among a plurality of bases, there is a conference system that enables a conference by connecting bases via a communication network (see Japanese Patent Application Laid-open No. 2009-065336 (JP-A-2009-065336), for example). In the conference system described in JP-A-2009-065336, the base processor connecting devices of various bases displays image data obtained from a plurality of the other conference base terminal devices on a single display screen, and displays, on each of image areas displaying the pieces of image data, a speaker level indicator that displays a level value linked to its own voice data output from the speaker unit of the corresponding another conference base terminal device.

In the conference system described in JP-A-2009-065336, it is necessary to gaze at a screen in order to grasp a base in which a person is speaking.

### SUMMARY

A voice output control device according to an embodiment includes: a base control unit configured to set, based on information on relative positions between an own base of the base control unit and other bases, a direction of a position where voice to be output to each of the other bases is localized, and set, based on information on relative distances between the own base and the other bases, a height of the position where the voice is localized; and a sound source processor configured to localize voice from the other base to generate a voice signal to be output, based on the position set by the base control unit.

A conference system device according to an embodiment includes a microphone configured to detect voice to generate a voice signal; a base communication device configured to perform communication including the voice signal with other bases; a voice output control device configured to localize the voice signal to be output from the other base; and speakers that are arranged in a given number of positions necessary to localize voice signals from the other bases as voice, each speaker being configured to output the voice signal generated by the voice output control device as voice. The voice output control device includes a base control unit configured to set, based on information on relative positions between an own base of the base control unit and other bases, a direction of a position where voice to be output to each of the other bases is localized, and set, based on information on relative distances between the own base and the other bases, a height of the position where the voice is localized; and a sound source processor configured to localize voice from the other base to generate a voice signal to be output, based on the position set by the base control unit.

A non-transitory computer-readable storage medium according to an embodiment stores a computer program causing a computer to execute: obtaining position information of an own base and other bases; setting, based on information on relative positions between the own base and the other bases, a direction of a position where voice to be output to each of the other bases is localized; setting, based on information on relative distances between the own base and the other bases, a height of the position where the voice is localized; and localizing voice from the other base to generate a voice signal to be output, based on the set direction and distance.

### BRIEF DESCRIPTION OF THE DRAWINGS

FIG. 1 is a block diagram illustrating an example of a conference system;

FIG. 2 is a schematic view illustrating the relative positions of bases in the conference system;

FIG. 3 is a schematic view illustrating the arrangement of various components in the conference system;

FIG. 4 is a block diagram illustrating a configuration of a conference system device according to an embodiment;

FIG. 5 is a block diagram illustrating a configuration of a base processor;

FIG. 6 is a flowchart illustrating an example of the operation of the conference system device;

FIG. 7A is an explanatory diagram for explaining another example of the operation of the conference system device;

FIG. 7B is an explanatory diagram for explaining another example of the operation of the conference system device; and

FIG. 8 is an explanatory diagram illustrating an example of a screen displayed on a monitor.

### DETAILED DESCRIPTION OF THE PREFERRED EMBODIMENTS

The following will describe an embodiment of the present disclosure on the basis of the drawings. This embodiment does not limit the present disclosure. In addition, the components in the following embodiment include those that are substitutable easily for a person skilled in the art, or those that are substantially the same.

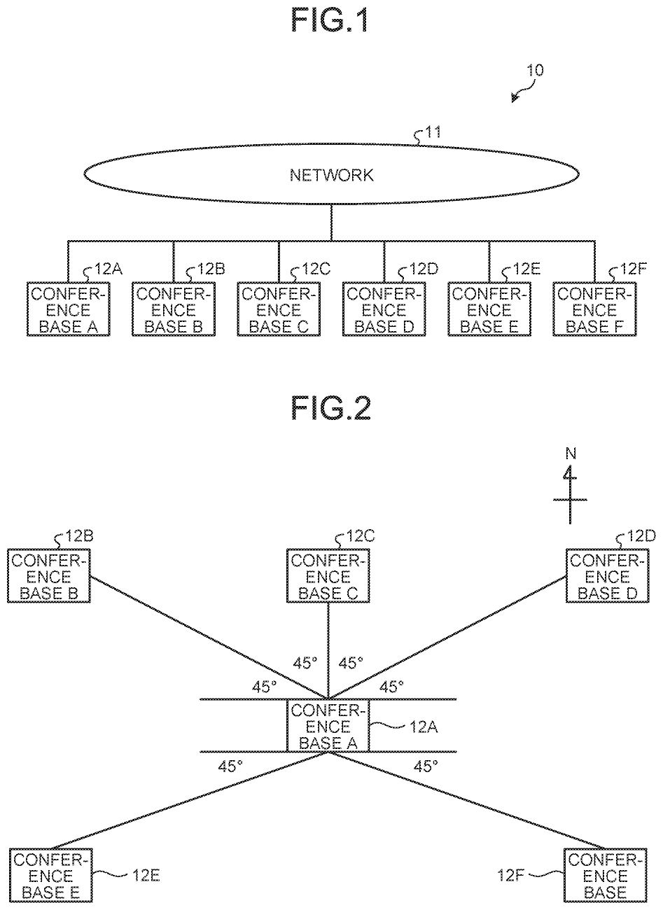

FIG. 1 is a block diagram illustrating an example of a conference system. A conference system 10 illustrated in FIG. 1 is a system that enables a conference, an explanatory meeting, or the like, through real-time communication performed among persons at various bases, such as remote bases.

As illustrated in FIG. 1, the conference system 10 includes a network 11 and a plurality of conference bases 12A, 12B, 12C, 12D, 12E, and 12F. In the drawings of the embodiment, the conference bases 12A, 12B, 12C, 12D, 12E, and 12F are illustrated as a conference base A, a conference base B, a conference base C, a conference base D, a conference base E, and a conference base F for identification. In the embodiment, the number of conference bases is six. However, the number thereof is not limited thereto. Hereinafter, even when a conference base is described as a base, it indicates the same.

The network 11 is a communication network constructed among a plurality of conference bases 12A, 12B, 12C, 12D, 12E, and 12F. The network 11 may be a public telecommunications network or a leased line. The network 11 is a communication network for data communication, and may be a telephone network for voice communication.

Each of the conference bases 12A, 12B, 12C, 12D, 12E, and 12F is connected to the other bases via the network. Each of the conference bases 12A, 12B, 12C, 12D, 12E, and 12F outputs voice, images, and position information obtained at its own base to the network 11, and receives voice, images, and position information supplied from the other bases via the network 11. The transmission and reception of images is not always necessary.

FIG. 2 is a schematic view illustrating the relative positions of various bases. The position relation of the conference bases 12A, 12B, 12C, 12D, 12E, and 12F is as illustrated in FIG. 2, with the conference base 12A as the center. In FIG. 2, the upper side corresponds to the north side. FIG. 2 is scaled unevenly in each direction to illustrate only the directions where the bases are actually located. The conference base 12B is located in the northwest direction (at 45° to the upper left direction) of the conference base 12A. The conference base 12C is located in the north direction (directly above) of the conference base 12A. The conference base 12D is located in the northeast direction (at 45° to the upper right direction) of the conference base 12A. The conference base 12E is located in the southwest direction (at 45° to the lower left direction) of the conference base 12A. The conference base 12F is located in the southeast direction (at 45° to the lower right direction) of the conference base 12A.

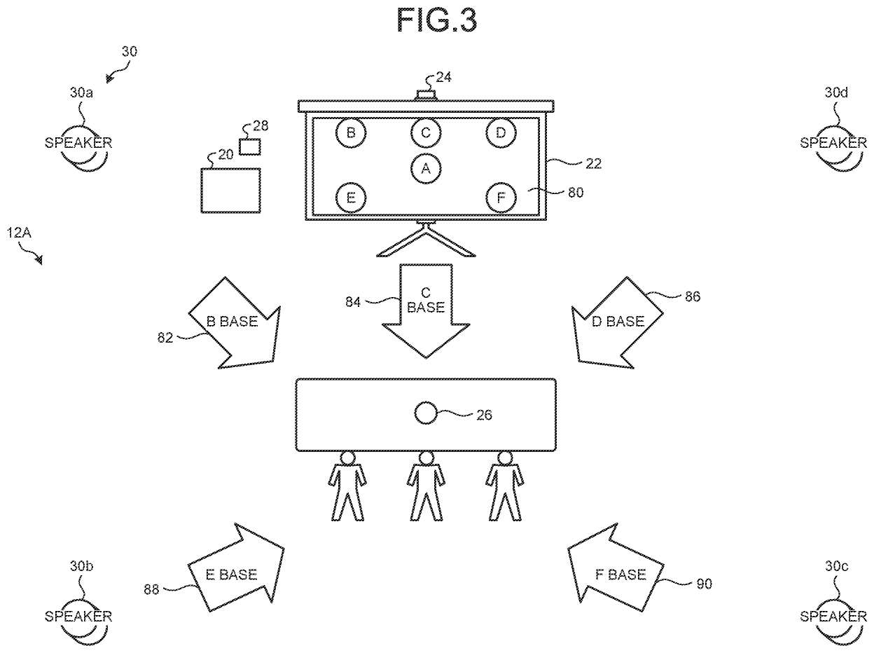

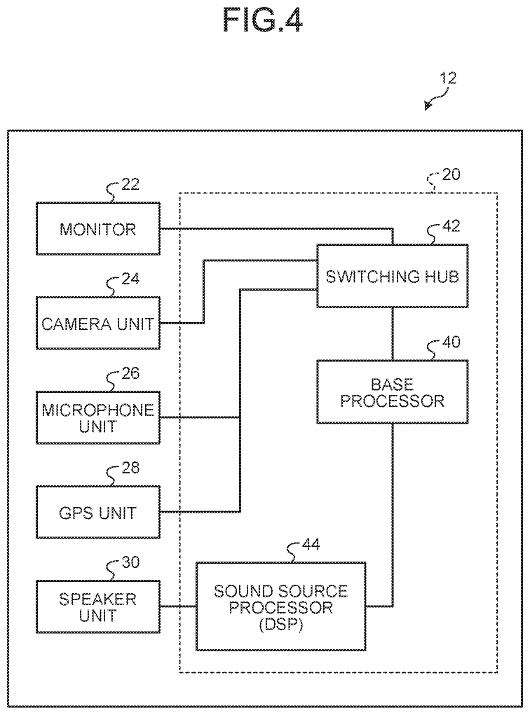

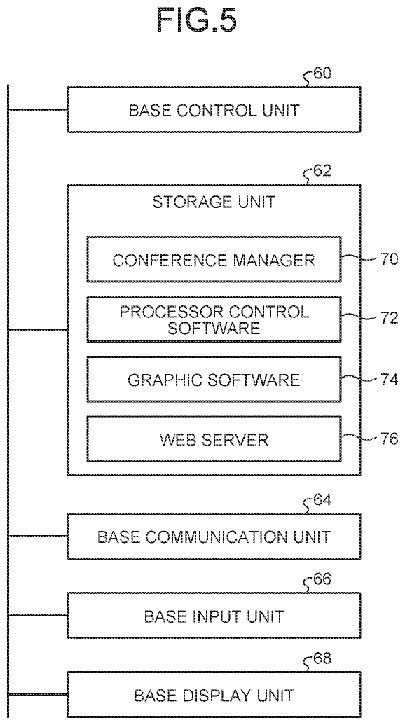

FIG. 3 is a schematic view illustrating the arrangement of various components of the conference system device at the conference base 12A. FIG. 4 is a block diagram illustrating a configuration of a conference system device 12 provided at each base. FIG. 5 is a block diagram illustrating a configuration of a base processor 40 of the conference system device 12. The conference bases 12A, 12B, 12C, 12D, 12E, and 12F have the same configuration. The following will describe the conference system device 12 at the conference base 12A using FIG. 3 to FIG. 5.

As illustrated in FIG. 3 and FIG. 4, the conference system device 12 includes a control device 20, a monitor 22, a camera unit 24, a microphone unit 26, a global positioning system (GPS) unit 28, and a speaker unit 30. Each unit of the conference system device 12 is provided in a space such as a conference room. First, the arrangement position of each unit of the conference system device 12 will be described using FIG. 3. In the conference base 12A, a table is located in the center. Participants in a conference are set to participate in a conference around the table. The control device 20 and the GPS unit 28 are arranged at arbitrary positions in the conference base 12A. The monitor 22 is arranged to face the table. At the conference base 12A, the surface where the monitor 22 is arranged is set as a front surface, with the table as a reference. The camera unit 24 is arranged on the monitor 22. The microphone unit 26 is placed to be movable on the table. The speaker unit 30 includes four speakers 30a, 30b, 30c, and 30d, which are provided respectively at the four corners of the conference base 12A, with the table as the center. The speaker 30a is arranged at the front surface left corner. The speaker 30b is arranged at the front surface right corner. The speaker 30c is arranged at the rear surface left corner. The speaker 30d is arranged at the rear surface right corner. A necessary number of speaker units 30 are arranged at given positions to localize voice from each of the other bases.

Next, the function of each unit of the conference system device 12 will be described using FIG. 4 and FIG. 5. The monitor 22 is a display device that displays images such as still images and moving images. The monitor 22 is a projector, a liquid crystal display (LCD), an organic electroluminescence (EL) display, or the like. The camera unit 24 captures images of the conference base 12A. The microphone unit 26 obtains voice of the conference base 12A. The GPS unit 28 is a global positioning system, which receives signals from a plurality of satellites and measures a position of the conference base 12A. The speaker unit 30 outputs voice signals output from the control device 20 as voice into the conference base 12A.

The control device 20 controls the operation of each unit of the conference system device 12. The control device 20 has the function of a voice output control device. The control device 20 includes a base processor 40, a switching hub 42, and a sound source processor 44. The switching hub 42 allows connection between the base processor 40 and each unit and the network 11. The switching hub 42 includes a connector to be connected to various terminals. The transmission and reception of data is possible by connecting the terminal of each unit to the connector. The sound source processor 44 is formed by a digital signal processor (DSP) or the like. The sound source processor 44 performs sound field localization processing on voice signals transmitted from the base processor 40 on the basis of the position information of each base so as to set the direction of the sound source, and outputs the localized voice signals to the speaker unit 30.

The base processor 40 performs various kinds of arithmetic operations in the conference system device 12. The base processor 40 is, for example, a personal computer or an electronic circuit device dedicated to the conference system 10. The base processor 40 includes a base control unit 60, a storage unit 62, a base communication unit 64, a base input unit 66, and a base display unit 68. The base control unit 60 performs various kinds of arithmetic processing on the basis of data and programs stored in the storage unit 62 and information input from each unit. The base control unit 60 includes an arithmetic circuit such as a central processing unit (CPU) and storage circuits such as a random access memory (RAM) and a read only memory (ROM).

The storage unit 62 stores various kinds of information. The storage unit 62 includes storages such as a hard disk drive and a solid state drive, for example. An external storage medium such as a removable disk may be used as the storage unit 62. The storage unit 62 includes a conference manager 70, a processor control software 72, a graphic software 74, and a web server 76. The base processor 40 is implemented as a voice output control program allowing the combination of the processor control software 72, the graphic software 76, and the web server 76 to perform an audio output control.

The conference manager 70 operates independently of the processor control software 72 when the conference manager function is enabled at the conference base 12A, and manages presentation information and grouping information. In other words, the conference manager 70 manages the information of a screen to be shared in a conference, and the information of bases participating in the conference.

The processor control software 72 performs a control of the camera unit 24 and the microphone unit 26 and a control of communication among the conference bases. The graphic software 74 generates image signals for display on the monitor 22. The web server 76 controls the operation of the base communication unit 64.

The base communication unit 64 transmits and receives data to and from other devices via the network 11. The base input unit 66 is a device for conference participants and operators to input various operations. The base input unit 66 is a touch sensor, a mouse, a keyboard, a remote controller, or the like. The base display unit 68 displays various kinds of information necessary for the processing of the conference system 10. The base display unit 68 may be a display device integrated with the base input unit 66, or a separate display device. In the conference base 12A, various kinds of information may be displayed on the monitor 22 without the base display unit 68.

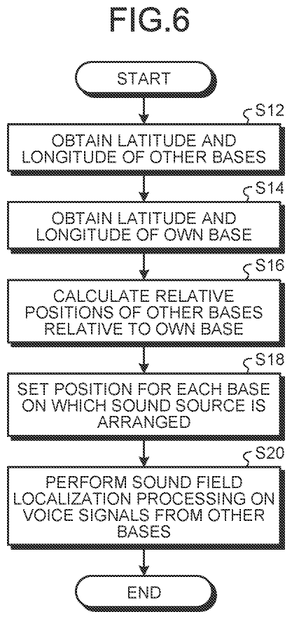

The following will describe an example of the operation of the conference system device 12 having the above-described configuration. FIG. 6 is a flowchart illustrating an example of the operation of the conference system device 12. The processing illustrated in FIG. 6 is realized by the base processor 40 of the control device 20 performing various kinds of processing.

The base processor 40 obtains the latitude and longitude information of each base (Step S12). The base processor 40 performs communication with the other conference bases via the network 11, and obtains the latitude and longitude information of the other bases. The base processor 40 obtains the latitude and longitude information of its own base (Step S14). The base processor 40 obtains the latitude and longitude information of its own base through the GPS unit 28.

The base processor 40 calculates the relative positions of the other bases relative to its own base (Step S16). The base processor 40 may calculate distances from its own base to the other bases. To be more specific, the base processor 40 calculates the relative position relation between its own base and each of the other bases, on the basis of latitude and longitude information. For example, in the embodiment, the information of the position relation illustrated in FIG. 2 is obtained.

The base processor 40 sets a position of the sound source for each base (Step S18). To be more specific, the base processor 40 sets a position of the sound source of voice to be output to each of the other bases in the conference room, on the basis of the relative position information of its own base and the other base. For example, with the position of its own base as the center, the direction where each of the other bases is actually located may be calculated, so that the position of the sound source of the other base is set in the direction to the location of the other base in the conference room. Alternatively, the position of the sound source of each of the other bases may be set by taking into consideration of a distance to the other base, on the basis of the relative position information of its own base and the other base. The base processor 40 outputs, to the sound source processor 44, voice signals transmitted from the other bases and the information of the positions of the sound sources set for the other bases.

The sound source processor 44 performs sound field localization processing on the voice signals from the other bases (Step S20). To be more specific, the sound source processor 44 performs sound field localization processing on the voice signals transmitted from the other bases, on the basis of the information of the position of the sound source at each of the other bases set by the base processor 40. For example, the sound field localization processing is performed on the voice signals transmitted from the conference base 12B so that the voice from the conference base 12B is heard by the participants at the conference base 12A with the sound source in the front left direction relative to the monitor 22 in the front direction. The same applies to the other bases. The voice signals having subjected to the sound field localization processing, which is performed based on the voice signal output from each of the other bases and the information of the position of the sound source, are supplied to each speaker.

With the above-described processing, the conference system device 12 outputs voice of each base from the direction set on the basis of the position of the base, as illustrated in FIG. 3. In the embodiment, with the direction from the table toward the monitor 22 as the north direction, the direction of voice to be output toward the table is set. As a result, the voice of the conference base 12B (B base) located on the northwest side of the conference base 12A, is output from the direction of an arrow 82 (45° to the upper left in FIG. 3). The voice of the conference base 12C (C base) located on the north side of the conference base 12A, is output from the direction of an arrow 84 (the upper direction in FIG. 3). The voice of the conference base 12D (D base) located on the northeast side of the conference base 12A, is output from the direction of an arrow 86 (45° to the upper right in FIG. 3). The voice of the conference base 12E (E base) located on the southwest side of the conference base 12A, is output from the direction of an arrow 88 (45° to the lower left in FIG. 3). The voice of the conference base 12F (F base) located on the southeast side of the conference base 12A, is output from the direction of an arrow 90 (45° to the lower right in FIG. 3). The conference system 10 may arbitrarily control the direction of the sound source (the direction from which voice is heard) through the sound source processor 44.

As illustrated in FIG. 3, the conference system 10 displays, on the monitor 22, an image 80 where the display positions of the bases are set on the basis of the relative positions of its own base and the other bases. The image 80 is an image with the upper direction of the screen corresponding to the north direction. In addition to the relative positions of the bases, images obtained by cameras at the bases may also be displayed.

As described above, the conference system 10 of the embodiment controls the output direction of voice so that the voice is heard from the direction in accordance with its relative position, on the basis of the relative position of each of the other bases, thereby allowing conference participants to grasp from which base the voice is obtained. In addition, the direction from which voice is heard is different for each base, making it possible to recognize, even when persons speak at the same time at a plurality of bases, from which bases they speak. In other words, in the present disclosure, it is possible to recognize from which base a person is speaking without depending on the visual sense. Thus, the monitor 22 is not indispensable, and a teleconference system does not have to include a monitor.

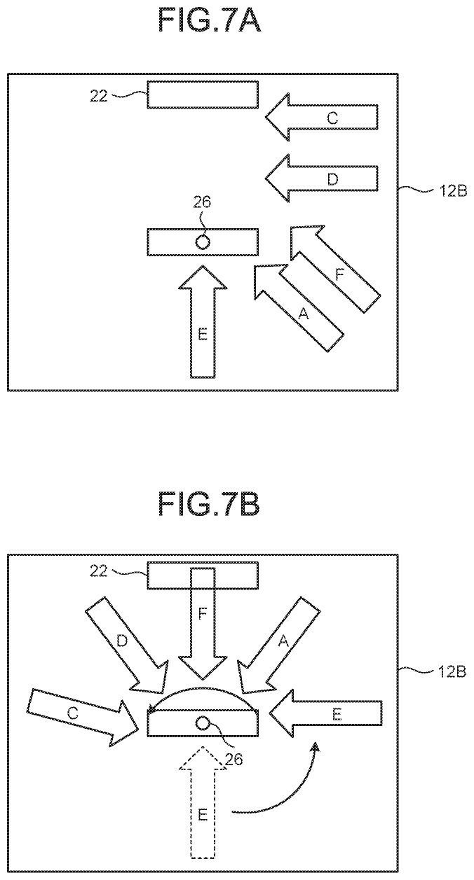

In the conference system 10 of the embodiment, the sound source directions of the bases may be rotated around its own base. In such a case, the settings of the sound source processor 44 are changed by the operation through the base input unit 66. The sound source processor 44 sets the sound source directions of the other bases in accordance with the relative positions of the bases rotated around its own base. For example, FIG. 7A illustrates the directions of the sound sources of the bases in the conference room of the conference base 12B illustrated in FIG. 2. In FIG. 7A, the conference system device 12 is arranged, similarly to the conference base 12A. FIG. 7A illustrates only the monitor 22 and the microphone unit 26. At the conference base 12B, the directions of the sound sources of the other bases are concentrated from the right side to the rear side, making it difficult to distinguish between the conference bases C and D and between the conference bases A and F. As illustrated in FIG. 7B, in the conference system device 12, the sound source directions are rotated so that the conference base F corresponds to the front direction of the conference room and a speech from each base is heard from a moderately different direction, so that the base in which a speaker is speaking is distinguishable.

In the conference system 10 of the embodiment, the information of the relative positions of the bases is displayed on the monitor 22 on the basis of the actual positions of the bases. Thus, it is possible to easily understand the relation between the direction from which voice is heard and the base. This makes it easier to distinguish each base and intuitively understand from which base a person is speaking.

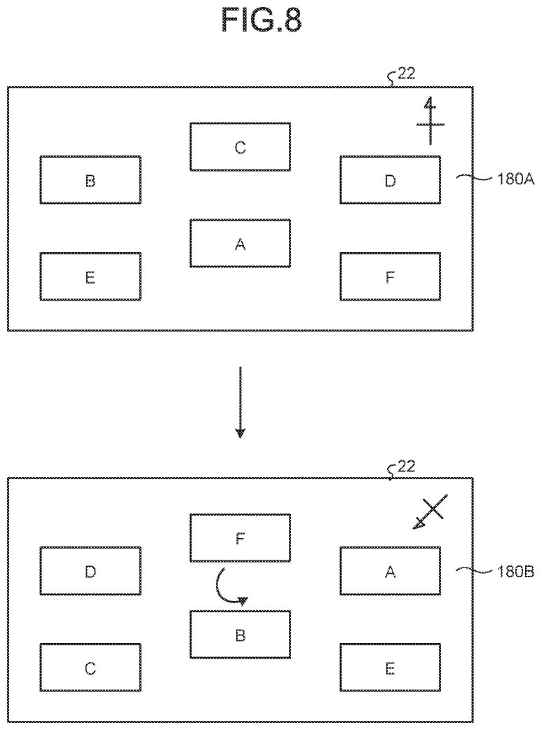

In the conference system device 12, when the sound source directions illustrated in FIGS. 7A and 7B are rotated around its own base, the positions of the bases displayed on the monitor 22 may be rearranged in accordance with the directions of the sound sources, as illustrated in FIG. 8. The display on the monitor 22 is switched from a screen 180A to a screen 180B. With the processing of rotating the positions of the bases displayed on the monitor 22 by the operation through the base input unit 66, the directions of the sound sources of the bases may be changed.

On the basis of the position information of the bases, the base processor 40 may shift the virtual positions of the bases so that an angle difference between the calculated directions of the sound sources of the adjacent bases is equal to or larger than a predetermined angle. Specifically, with the own base as the center, the order of the bases on the rotation coordinates remains the same, while the angles between the bases may be changed. In this manner, it is easier to distinguish the bases on the basis of the directions from which voice is heard.

The conference system 10 may adjust positions where the sound sources are localized in accordance with distances between its own base and the other bases so that a farther sound source emits voice from a higher position. For example, if a plurality of other bases are located in substantially the same direction but with different distances from its own base, the sound sources are in the same direction, while the voice from a farther base is emitted from a higher position. In the embodiment, for the conference base 12E, the conference bases 12A and 12C are located in the slightly right direction relative to the front direction, and the voice of the conference base 12C is emitted from a higher position than the voice of the conference base 12A. In addition, for the conference base 12E, the voice of the conference base 12D is emitted from a sound source at a further higher position than the voice of the conference base 12A. In this manner, it is possible to distinguish the bases on the basis of a difference in the height direction of voice heard. It is possible to express the difference in actual relative position relation as the difference in vertical position.

The localizing directions of the sound sources of the other bases may be arranged horizontally on the basis of the position information as well as vertically in the front in accordance with the positions of the other bases displayed on the monitor 22. In this case, a distance from the monitor 22 to the sound source is set on the basis of a distance to each of the other bases. For example, the sound source is set to be farther from the monitor 22 as the actual position of the base is farther. There may be no object to gaze at, such as a monitor, and the sound sources of the other bases may be localized in the vertical direction relative to a certain direction in the conference room.

The technical scope of the present disclosure is not limited to the above-described embodiment, and changes may be made as appropriate without departing from the spirit and scope of the present disclosure. For example, in the above-described embodiment, each of the conference bases 12A, 12B, 12C, 12D, 12E, and 12F of the conference system 10 obtains the position of its own base using the GPS unit 28. However, there may be adopted position information detection means or a position information setting method without using the GPS. For example, the position may be obtained from the IP address. Alternatively, the address information of each conference base may be input to calculate the position thereof using the address information and map information. The position information may also be input by an operator. In other words, it only needs to be own base position information determination means that determines the position information of its own base for each base.

In this embodiment, the speaker unit 30 includes a plurality of speakers, which are arranged at various positions such that voice is output from various directions. However, the embodiment is not limited thereto. In the conference system 10, the speaker unit 30 may provide a directivity to voice output from a speaker, and control the direction of the voice heard by conference participants by reflection of the voice on a wall or the like in a conference base. In this case, the speaker unit 30 is able to output voice from a plurality of directions with a single speaker, for example. In a case where all participants in a conference use headphones, earphones, or the like, it is possible to adjust the voice output balance between the left and right and control the directions of the sound sources. In this case, the information of which direction the conference participants direct at may be obtained to control the direction from which voice is heard.

As an embodiment of the present disclosure, the control device 20 (voice output control device) has been described using a conference system as an example. However, the voice output control device of the present disclosure is not limited to the conference system. The positions of the sound sources of voice from the other bases that are communication partners in wireless communication may be localized on the basis of the relative positions of its own base and the other bases and the distance therebetween. If the communication device is an in-vehicle communication device, the sound sources of the other bases are localized on the basis of the relative positions of the own base and the other bases and the distance therebetween, and output by a plurality of speakers provided in a vehicle, similarly to the conference system. If the communication device is a portable communication device, the directions of the sound sources may be controlled for the use of a headphone or the like.

The voice output control program described above may be provided by being stored in a non-transitory computer-readable storage medium, or may be provided via a network such as the Internet, so that the voice output control program is executed by a computer. Examples of the computer-readable storage medium include optical discs such as a digital versatile disc (DVD) and a compact disc (CD), and other types of storage devices such as a hard disk and a semiconductor memory.

According to the present disclosure, it is possible to easily grasp from which base a person is speaking.

Although the present disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A voice output control device, comprising:
a base control unit configured to set, based on information on relative positions between an own base of the base control unit and other bases, a direction of a position where voice to be output to each of the other bases is localized, and set, based on information on relative distances between the own base and the other bases, a height of the position where the voice is localized; and
a sound source processor configured to localize voice from the other base to generate a voice signal to be output, based on the position set by the base control unit.

2. The voice output control device according to claim 1, wherein the base control unit sets the position to a position where a direction in which voice from the other base is localized is rotated to an arbitrary direction while keeping a position relation based on information on a relative position and a relative distance between the own base serving as a center and the other base.

3. A conference system device, comprising:
a microphone configured to detect voice to generate a voice signal;
a base communication device configured to perform communication including the voice signal with other bases;
a voice output control device configured to localize the voice signal to be output from the other base; and
speakers that are arranged in a given number of positions necessary to localize voice signals from the other bases as voice, each speaker being configured to output the voice signal generated by the voice output control device as voice, wherein
the voice output control device includes:
a base control unit configured to set, based on information on relative positions between an own base of the base control unit and other bases, a direction of a position where voice to be output to each of the other bases is localized, and set, based on information on relative distances between the own base and the other bases, a height of the position where the voice is localized; and
a sound source processor configured to localize voice from the other base to generate a voice signal to be output, based on the position set by the base control unit.

4. The conference system device according to claim 3, wherein the base control unit sets the position to a position where a direction in which voice from the other base is localized is rotated to an arbitrary direction while keeping a position relation based on information on a relative position and a relative distance between the own base serving as a center and the other base.

5. The conference system device according to claim 3, further comprising a display device configured to display information from the other bases, wherein
the voice output control device causes the display device to display an image representing at least a direction in which the voice is localized.

6. The conference system device according to claim 5, wherein the base control unit sets the position to a position where a direction in which voice from the other base is localized is rotated to an arbitrary direction while keeping a position relation based on information on a relative position and a relative distance between the own base serving as a center and the other base, causes the sound source processor to generate a voice signal, and causes the display device to rotate an image to be displayed.

7. The conference system device according to claim 6, further comprising a capturing device, wherein
the image includes an image captured by the capturing device at the other base.

8. A non-transitory computer-readable storage medium storing a computer program causing a computer to execute:
obtaining position information of an own base and other bases;
setting, based on information on relative positions between the own base and the other bases, a direction of a position where voice to be output to each of the other bases is localized;
setting, based on information on relative distances between the own base and the other bases, a height of the position where the voice is localized; and
localizing voice from the other base to generate a voice signal to be output, based on the set direction and distance.
